(19) United States
(12) Patent Application Publication
(10) Pub. No.: US 2021/0216955 A1
(43) Pub. Date: Jul. 15, 2021

(54) AUGMENTED REALITY BASED PACKAGE FINDING ASSISTANCE SYSTEM

(71) Applicant: ARRIVAL LIMITED, Banbury Oxfordshire (GB)

(72) Inventor: Dmitry GIZATOV, Saint-Petersburg (RU)

(21) Appl. No.: 16/761,879

(22) PCT Filed: Nov. 6, 2018
(86) PCT No.: PCT/GB2018/053220

§ 371 Date: May 6, 2020

(30) Foreign Application Priority Data
Nov. 7, 2017 (RU) 2017138564

(51) Int. Cl. G06Q 10/08; G06T 7/90; G06T 19/00; G06F 3/01; G06T 7/70

(52) U.S. Cl. CPC G06Q 10/0832; G06T 7/90; G06Q 10/0875; G06T 7/70; G06T 19/006; G06F 3/011; G06Q 10/0833

(57) ABSTRACT

A method of loading a package inside a container is presented. The method includes reading a first indicator containing information of the package with an electronic device, transmitting the information of the package and the identification of the container to a server, identifying, after the package is loaded inside the container, the position of the package in the container by controlling a first imaging device and a second imaging device arranged to image the internal space of the container, transmitting the position of the package to the server, and generating a second indicator containing information of the package, the position of the package and the identification of the container.

### TECHNICAL FIELD

This specification relates to an AR (Augmented Reality)-based assistant system. Particularly, but not exclusively, this specification relates to an AR-based assistant system for searching packages inside trucks or containers.

### BACKGROUND

Packages inside a container are often, at least visually, barely distinguishable from one another when viewed as a group through, for example, an open door of a shipping container. Each package can be identified fully only by the ID or delivery address, which should be recorded separately. In order to expedite the location and unloading process of the packages, often the packages are loaded into the container following a certain order or according to the numbering of the shelves inside the container, but this often still leaves the exact locations of particular packages unknown and difficult to identify.

### SUMMARY

This specification provides a system for efficiently loading and unloading packages to and from a container, based on an augmented reality and computer vision. For example, when the package is loaded into a container, the system may register its location within the container. When the desired package is to be unloaded, the user can look for it in a list on a display of their mobile device, such as a smartphone, tablet etc., direct the device's camera at the container and view the display. The display may provide a viewable augmented reality interface which visually directs the user as to the location of the package in the container.

This specification provides a method of loading a package inside a container. The method may comprise reading a first indicator containing information of the package with an electronic device, transmitting the information of the package and the identification of the container to a server, identifying, after the package is loaded inside the container, the position of the package in the container by controlling a first imaging device and a second imaging device arranged to image the internal space of the container transmitting the position of the package to the server, and generating a second indicator containing information of the package, the position of the package and the identification of the container.

This specification also provides a method of loading a package inside a container. The method comprises receiving a first indicator containing information of the package read by an electronic device and the identification of the container, identifying, after the package is loaded inside the container, the position of the package by controlling a first imaging device and a second imaging device arranged to image the internal space of the container, and generating a second indicator containing information of the package, the position of the package and the identification of the container.

The identifying may further comprise estimating the position of the package relative to the walls of the container via a triangulation algorithm.

The walls of the container may be a different colour than that of the package.

The predetermined tag may be attached to the package, wherein the predetermined tag is recognisable by the first imaging device and the second imaging device.

The identifying may further comprise obtaining a first image before the package is loaded into the container, obtaining a second image after the package is loaded into the container, and comparing the first image and the second image.

The first imaging device may be installed on a side surface of the container and the second imaging devices is installed on a top surface of the container.

This specification also provides a method of locating a package inside a container. The method comprises reading an indicator assigned to the container with an electronic device, retrieving, by accessing a server with the indicator, the identity of the container, information of packages loaded inside the container, and positions of the respective packages, providing on the electronic device the list of the packages loaded inside the container, receiving a user input selecting one of the packages displayed on the electronic device, and displaying, on an augmented reality interface, the position of the selected package overlaid on the image of the container.

The augmented reality interface may be included in the electronic device and the electronic device further comprises an imaging device, such that the augmented reality interface displays the image obtained by the imaging device.

The method may further comprise receiving a further user input regarding whether the exterior or the interior of the container is to be imaged on the augmented reality interface.

If the user input is received for imaging the interior of the container, the displaying on the augmented reality interface may further comprise determining, from the image of the interior of the container, the surfaces corresponding to the walls of the interior the container, displaying a 3-dimensional object corresponding to the combination of the determined surfaces, such that the 3-dimensional object represents the internal space of the container, overlaid with the displayed image of the interior of the container, and displaying a pointer pointing to the position of the selected package overlaid on the image of the internal space of the container.

If at least one or more packages block the selected package from being displayed on the augmented reality interface, the displaying on the augmented reality interface further comprises displaying a pointer pointing to the one or more packages blocking the selected package.

If the user input is received for imaging the exterior of the container, the displaying on the augmented reality interface may further comprise determining, from the image of the exterior of the container, visible external surfaces and hidden external surfaces corresponding to the walls of the container, displaying a 3-dimensional object corresponding to the combination of the determined surfaces, such that the 3-dimensional object represents the space occupied by the container, overlaid with the displayed image of the container, and displaying a pointer indicating the position of the selected package within the 3-dimensional object.

### BRIEF DESCRIPTION OF THE DRAWINGS

Embodiments of the present invention will now be described, by way of example only, with reference to the accompanying drawings, in which:

FIG. 1a is schematic illustrations which describe an example scenario in which the first indicator attached onto a package to be loaded into a container may be read by an electronic device.

FIG. 1b is schematic illustrations which describe an example scenario in which the image of the interior of a container is obtained by a first imaging device and a second imaging device before and after the package is loaded into a container.

FIG. 1c is schematic illustrations which describe an example scenario in which a second indicator is generated which includes information of all of the packages loaded in a container for efficient retrieval later.

FIG. 2a is schematic illustrations which describe performing a triangulation algorithm to obtain the position information of the package within a container.

FIG. 2b is schematic illustrations which describe how a first imaging device images the interior of the container before and after a package is loaded.

FIG. 2c is schematic illustrations which describe how a second imaging device images the interior of the container before and after a package is loaded.

FIG. 3 is a flowchart of a method of calculating a 3-dimensional coordinate of a position of a package inside an interior of a container.

FIG. 4a is schematic illustrations which describe how a second indicator attached on a container is sensed by an electronic device.

FIG. 4b is schematic illustrations which describe a first user interface included in an electronic device.

FIGS. 4c and 4d are schematic illustrations of two different types of an augmented reality device.

FIGS. 5a, 5b, 6a and 6b are, respectively, schematic illustrations which show the how a package is unloaded using an augmented reality interface to image an interior of a container.

FIGS. 7a and 7b are schematic illustrations which show how a package is unloaded using an augmented reality interface to image an exterior of a container.

FIG. 8 is a flowchart of a method of loading a package inside a container.

FIG. 9 is a flowchart of a method of loading a package inside a container.

FIG. 10 is a flowchart of a method of locating a package inside a container.

### DETAILED DESCRIPTION

An efficient method of expediting the process of loading, building an inventory, unloading and locating the packages in a container, such as a shipping container or truck haulage space, is much needed in the area of logistics. The techniques described herein provide such a method. The method provides for energy-efficient loading and unloading of a container, for example when carried out manually or automatically using one or more robotic elements, and may additionally or alternatively allow for such containers to be loaded and unloaded in a short amount of time.

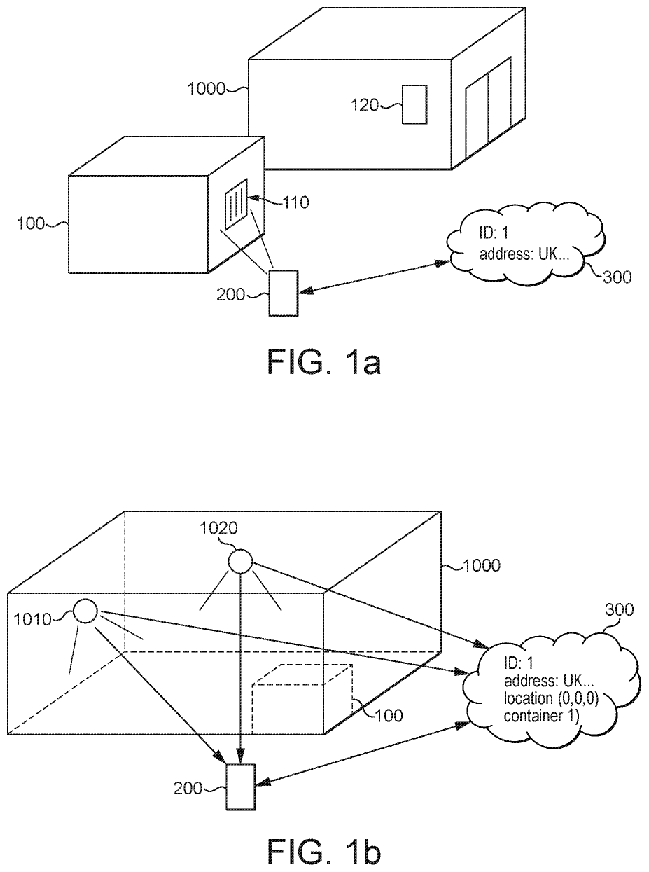

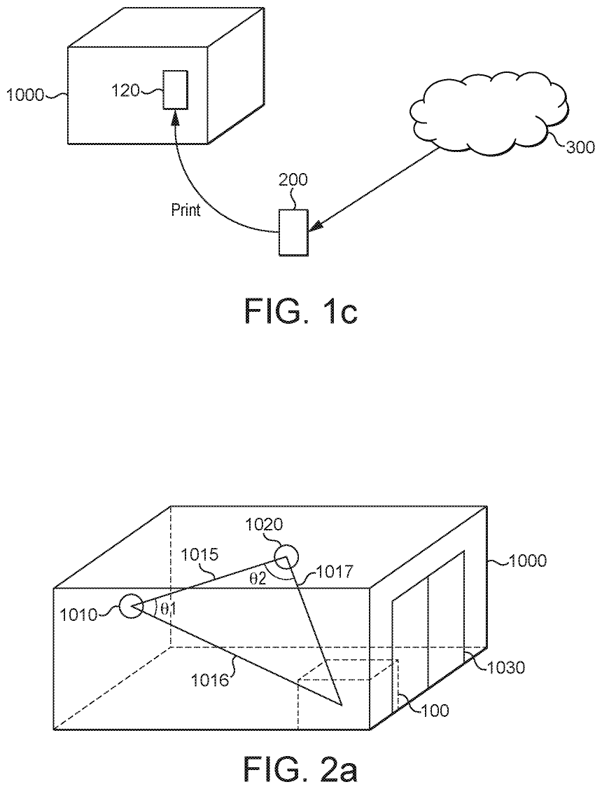

FIGS. 1a, 1b and 1c describe a method of loading a package 100 inside a container 1000.

In FIG. 1a, the package 100, to be loaded into the container 1000, may contain a first machine-readable indicator 110 attached and displayed on the outer surface of the package 100 such that the first indicator 110 is accessible without opening the package 100. The first indicator 110 may include or be encoded to include information concerning the package 100 such as a package identification number, a brief description or categorisation of the content of the package, any special information for handling, and the addresses of the origin and/or the destination. Examples of the first indicator 110 include, but are not limited to, one or more of QR codes, Barcodes or RFID tags. Alternatively, the first indicator 110 may include or be encoded to include references or pointers to the information concerning the package 100, which may itself be stored in a computer server 300. Alternatively, the first indicator may include a text corresponding to the information. As described in more detail below, the server 300 may be remotely accessible by an electronic device 200 via a communication network. Examples of the network include, but are not limited to, the internet, a Bluetooth connection, a Wi-Fi connection, an NFC (Near-Field Communication) connection, and any antenna-transceiver system capable of wireless communication of data between the electronic device 200 and the server 300.

An electronic device 200 may be configured such that the information contained in the first indicator 110 or the information referenced by the references contained in the first indicator 110 and stored in the server 300, can be retrieved. An example of the electronic device 200 includes, but is not limited to, a mobile user device with a built-in camera, such as a smart phone or tablet computer, with a specialised software application installed in a memory of the device. Additionally or alternatively, the mobile user device may comprise an RFID reader, a barcode scanner, and/or an apparatus providing the device with NFC capability.

The first indicator 110 may contain, or be encoded to contain the information associated with the package 100 and can be read by the electronic device 200. The first indicator 110 may be in any form that can readily be attached to, and/or displayed on, the package 100. For example, if the first indicator 110 is in an electronic format, such as an image file, or machine-readable markings describing the image file, the first indicator 110 may be generated and stored in the server 300. This electronic version of the first indicator 110 may be redeemed and printed to form the first indicator 110 in the form of a machine-readable label. The label may then be attached onto the external surface of the package 100. Any other form of hard copy of the first indicator 110 or means of displaying the first indicator attachable to the package 100 may be used. For example, a paper-like display technology such as electronic ink may be used to display the first indicator.

FIG. 1a shows that when the package 100 is loaded onto the container 1000, the electronic device 200 may be used to sense the first indicator 110 to retrieve the information associated with the package 100. For example, the electronic device 200 may be brought relatively close to the first indicator 110 so that printed image data containing, or pointing to, the information associated with the package can be read using a camera of the electronic device 200. The information associated with the package 100 may be read directly from the first indicator 110 if the first indicator 110 includes all of the information. Alternatively, the electronic device 200 may access the server to retrieve the information associated with the package 100 referenced or pointed at by the first indicator 110. The electronic device 200 may access the server 300 in a wireless manner such as via a Wi-Fi network or using RF communication. However, any fashion of communication facilitating communication between the electronic device 200 and the server 300 may be adopted. For example, the electronic device 200 may communicate with the server 300 via an electrical or optical cable or a wired Local Area Network.

FIG. 1a illustrates an example scenario in which the first indicator 110 may be read by the electronic device 200. In the illustrated scenario, the first indicator 110 takes the form of a printed label containing a visual image containing or encoded to contain information associated with the package 100. The visual image displayed on the first indicator 110 is captured using a camera of the electronic device 200. The electronic device 200 is configured to derive the information from the captured image data of the first indicator 110 and to transmit the information, over a network, to the server 300.

At the server 300, it may be established based on the information received from the electronic device 200, that the package 100 identifies with one of the packages whose information is already stored in the server 300. Alternatively, the server 300 may determine from the received information that the package 100 does not match with a package whose information is already stored at the server 300. In case the information of the package 100 is not already stored at the server 300, the server 300 may implement a registration process in which the received information concerning the package 100 is used to register the package at the server 300.

A second indicator 120 may be attached on the external surface of the container 1000. The second indicator 120 includes or is encoded to include or serves as a reference to the information associated with the identification of the container 1000. The second indicator 120 may be in any form that can be attached and displayed on the container 1000.

In FIG. 1b, the package 100 is loaded into the container 1000. In this specific example, the package 100 is placed in the lower rightmost corner of the container 1000. The container 1000 may include a first imaging device 1010 and a second imaging device 1020, installed in the interior of the container 1000. The first imaging device 1010 and the second imaging device 1020 may be configured to image the interior of the container 1000. The first imaging device 1010 and the second imaging device 1020 may be configured to communicate with the electronic device 200, preferably in a wireless manner such as via a Wi-Fi network or an RF communication network.

Therefore, in the scenario illustrated in FIG. 1b, an image of the interior of the container 1000 may be obtained by the first imaging device 1010 and the second imaging device 1020. Optionally, the container 1000 may include at least one or more further imaging devices (not shown), which may also be configured to image the interior of the container. The images of the interior of the container 1000 include the newly loaded package 100.

The images of the interior of the container 1000, as captured by at least the first and second imaging devices 1010, 1020, may be transmitted to the electronic device 200. The images may be processed by the electronic device 200 to obtain a position information of the package 100, relative to the space envelope of the container 1000 as a whole. For example, the electronic device 200 may include software configured to triangulate the location of the package 100 inside the container 1000 using the images provided by at least the first and second image capture devices 1010, 1020. The triangulation will be discussed in more detail later. The position information of the package 100 may be transmitted by the electronic device 200 to the server 300.

Alternatively, the images of the package 100 may be transmitted directly by the first imaging device 1010 and the second imaging device 1020 to the server 300, without being transmitted to the electronic device 200. The images may be processed by the server 300, for example in the manner described above with respect to the electronic user device 200, to obtain position information for the package 100 relative to the space envelope of the container 1000 using a triangulation algorithm.

Alternatively, the image of the package 100 may be first transmitted to the electronic device 200, and the electronic device 200 may subsequently transmit the image of the package 100 to the server 300. The image may be processed by the server 300 to obtain a position information of the package 100. Compared to the electronic device 200, the server 300 may have a larger computational capacity to process the image and to extract the position information of the package 100. On the other hand, if the size of the image file or video file obtained by the imaging devices 1010, 1020 is large, the transmission may take a long time or may not be compatible with the capacity of the network available between the electronic device 200 and the server 300. Therefore, the specific fashion in which the images obtained by the imaging devices 1010, 1020 are stored and processed may be determined considering the hardware and the network conditions.

At the server 300, in case the information regarding the package 100 is already stored in the server 300, the location of the package 100 inside the container 1000, obtained by processing the images obtained by the imaging devices 1010, 1020, may be appended to the information associated with the package 100, i.e. after the package 100 has been loaded into the container 1000.

The position information of the package 100 may be in the form of a coordinate in a 3-dimensional space defined by the interior of the container. The position information may be in any form of data that can be used for an augmented reality interface such that it aids a user, or a computer operating a robotic arm, for example, to identify the position of the package 100 without difficulty.

Preferably, the position information of the package 100 may also include the extent of the volume occupied by the package 100. The position information of the package 100 may also include the relevant dimensions of the package 100 in case it is of a standard shape, such as three sides of a cube. The position information of the package 100 may also include any information regarding the shape of the package 100 in case it deviates from the standard shape of a cube. The position information of the package 100 may also include any information which will be relevant to stacking and arranging the package 100 inside the interior of the container 1000. For example, whether any other packages can be stacked on top of the package 100 may be included. When the images obtained by the first imaging device 1010 and the second imaging device 1020 are transmitted to the server 300, or the position information obtained by the electronic device 200 are transmitted to the server, the identification of the container 1000 may be transmitted simultaneously. The identification of the container 1000 may be indicated by the second indicator 120 attached on the external surface of the container 1000. The second indicator 120 may be scanned by the electronic device 200 when the package 100 is loaded to indicate association with the newly loaded package 100 and the container 1000. Alternatively, the identification of the container 1000 may be input by the user. Alternatively, the identification of the container may be associated with and stored in either one of or both the first imaging device 1010 and the second imaging device 1020 installed inside the container 1000. When the images obtained by the imaging devices 1010, 1020 are transmitted, the identification of the container may be transmitted simultaneously by the first imaging device 1010 and/or the second imaging device 1020. When the obtained images are transmitted to either the electronic device 200 or the server 300, the identification of the container may also be transmitted as part of the image obtained by the imaging device 1010, 1020. For example, the images obtained by the first imaging device 1010 and the second imaging device 1020 may be labelled with the identification of the container along with the recorded time. Alternatively, the identification of the container 1000 may be written as text on various parts of the wall of the interior of the container 100 and imaged by the imaging device 1010, 1020. These text may be converted into machine-compatible form via methods such as optical character recognition (OCR).

In FIG. 1c, the server 300 may generate an electronic form of a second indicator 120. The second indicator 102 may include or be encoded to include the information associated with the package 100, including the position information of the package 100 and/or the coordinate of the package 100 in the interior of the container 1000, associated with the identification of the container 1000. Alternatively, the second indicator may include or be encoded to include a reference to the information associated with the package 100 including the position information of the package 100, with the coordinate of the package 100, associated with the identification of the container 1000. The server 300 may transmit the electronic form of the second indicator 120 to the electronic device 200.

Alternatively, the electronic device 200 may communicate to the server 300 to access the information stored in the server 300. The electronic device 200 may subsequently generate the electronic form of the second indicator 120 which includes or is encoded to include or serves as a reference to the information associated with the package 100, including the position information of the package 100, the coordinate of the package 100 associated with the identification of the container 1000.

The electronic form of the second indicator 120 may be an electronic file such as image file. The electronic form of the second indicator 120 may be in any form that can readily be turned into a printed label that can be attached and displayed on the package 100. For example, if the electronic form of the second indicator 120 is an image file, the second indicator 120 may be printed to be attached on the external surface of the container 1000. Any other form of hard copy of the second indicator 120 or means of displaying the first indicator attachable to the container 1000 may be used. For example, a tablet PC type of monitor or an electronic ink type monitor may be permanently attached to the container 1000 on which the second indicator 120 may be displayed. The second indicator 120 may contain or be encoded to contain information associated with the package 100.

The second indicator 120 may be in any suitable form that may later be read or sensed by the electronic device 200. The examples include but are not limited to barcodes, RFID or texts. Preferably, the second indicator 120 may be QR codes.

The container 1000 may contain more than one package, in addition to the package 100 that is newly loaded in the scenario of FIG. 1b. In this case, the second indicator 120 may include or be encoded to include information or references to the information of all of the packages that are registered in the server 300 as currently loaded in the container 1000. Therefore, whenever a new package 100 is loaded into the container 1000, a new second indicator 120 may be generated by the server 300. The newly generated second indicator 120 may be transmitted to the electronic device 200 whenever the information in relation to the packages loaded in the container 1000 is updated. Alternatively, the second indicator 120 may be newly generated and transmitted to the electronic device 200 only when the user requests.

The first indicator 11o, to be attached on the package 100, and the second indicator 120, to be attached on the container may be in the same format or in different formats. Since the second indicator 120 may contain all of the information of all the packages inside the container 1000, if the second indicator 120 contains or is encoded to contain the information of the packages 100 loaded in the container 1000, the second indicator 120 may be in a format that can contain a larger amount of data. In one of the embodiments, the first indicator 110 may be barcodes and the second indicator 120 may be QR codes. However, if the second indicator 120 merely serves as a reference to the information of the packages 100 loaded inside the container stored in the server 300, the second indicator 120 may be a in a format that can hold enough information corresponding to the reference.

After the container 1000 is loaded with the package 100 and after the updated second indicator 120 is attached to the container 1000 or displayed on the container 1000, the container 1000 may be shipped off or transported to a destination.

The second indicator 120 on the container 1000 may be arranged such that at any stage of transportation, the second indicator 120 may be accessed by personnel handling the container 1000 using the electronic device 200.

The second indicator 120 attached on the container 1000 may serve as a convenient label that contains the inventory information of the packages and the respective positions of the packages 100.

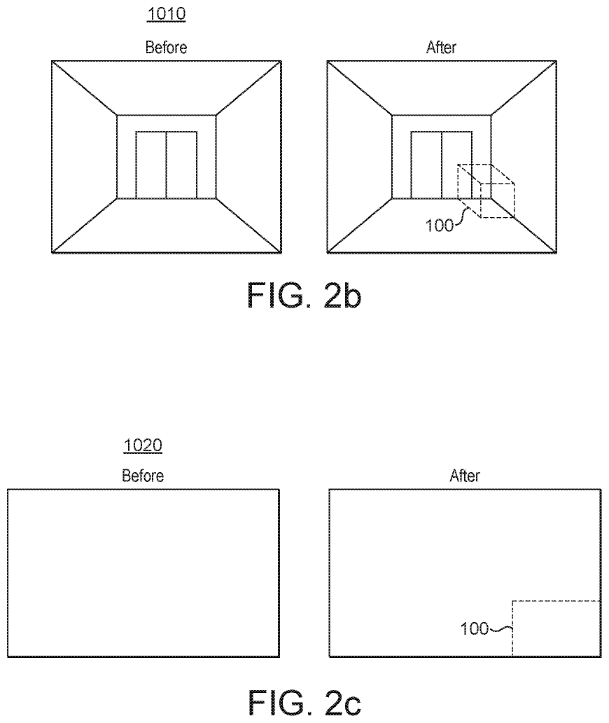

FIGS. 2a, 2b and 2c describe an exemplary scenario of how the position information of the package 100 or the 3-dimensional coordinate of the position of the package 100 may be obtained from the images obtained by the first imaging device 1010 and the second imaging device 1020. In particular, a triangulation algorithm is used in this specific scenario. However, any other algorithms suitable for obtaining the position information of the package 100 using the imaging devices 1010, 1020 may be used.

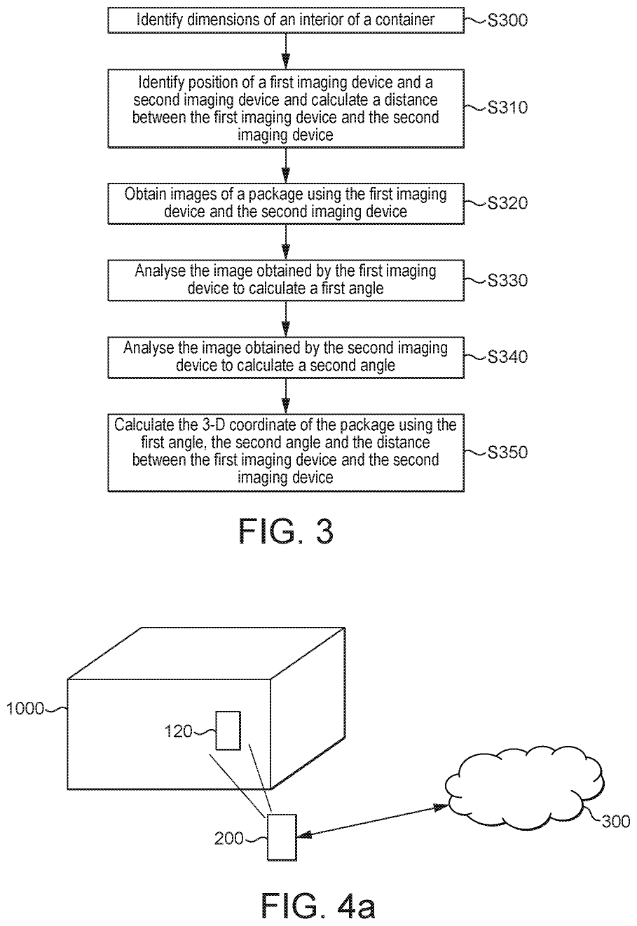

FIG. 3 shows the flowchart of the method of calculating the position information or the 3-dimensional coordinate of the position of the package 100 inside the interior of the container 1000. Each step in the flowchart will be referred to while explaining the method using the example of FIG. 2.

FIG. 2a shows the container 1000 and the first imaging device 1010 and the second imaging device 1020 installed in the interior of the container 1000. In this specific example, the package is loaded into the lower rightmost corner of the container 1000.

The container 1000 may include a door 1030 of the container 1000, through which the package 100 can be transferred and loaded inside the interior of the container 1000. In this specific example, in which the container 1000 is assumed to be of a cubic shape, the door 1030 is disposed on the right facing wall of the container 1000. Preferably, at least two imaging devices 1010, 1020 may be used for obtaining image of the package 100 in the interior of the container 1000. One or more imaging devices can be used in addition to the first imaging device 1010, and the second imaging device 1020. In case the container 1000 is of a cubic shape, preferably, the first imaging device 1010 may be disposed on the wall opposite the wall including the door 1030 and the second imaging device 1020 may be disposed on the top wall facing downwards the interior of the container 1000. However, the arrangement of the first imaging device 1010 and the second imaging device 1020 are not limited to this example. Any arrangements of imaging devices 1010, 1020 suitable for implementation of the triangulation algorithm may be used.

The examples of the first imaging device 1010 and the second imaging device 1020 may include but are not limited to the kinds of cameras compatible with closed-circuit television (CCTV) system, closed-circuit digital photography (CCDP) system, and IP cameras.

In a preferred embodiment, the spatial position of the package 100 in the 3-dimensional space defined by the interior of the container may be calculated by a triangulation algorithm. The triangulation algorithm is widely used in various fields of technology such as surveying. For implementation of the triangulation algorithm, at least two imaging devices are necessary and the distance between the two imaging devices should be known. Therefore, when the first imaging device 1010 and the second imaging device 1020 are installed inside the internal envelope of the container 1000, the distance between the first imaging device 1010 and the second imaging device 1020 may be measured. Alternatively, the distance between the first imaging device 1010 and the second imaging device 1020 may be predetermined and the first imaging device 1010 and the second imaging device 1020 may be installed accordingly. Preferably, the dimensions of the interior space of the container 1000 is known, associated with the identity of the container 1000, and the exact positions of the first imaging device 1010 and the second imaging device 1020 are predetermined accordingly. In the triangulation algorithm, the positions of the two imaging devices and the object whose 3-dimensional position is to be identified form a triangle. By imaging the object, the plane of the triangle is identified and the angles are determined. If the positions of the first imaging device 1010 and the second imaging device 1020 are predetermined, this plane of the triangle is known prior to installation of the first imaging device 1010 and the second imaging device 1020. If the positions the first imaging device 1010 and the second imaging device 1020 are not predetermined, at least the distance between the first imaging device 1010 and the second imaging device 1020 must be measured after installation. Preferably, the exact position of the first imaging device 1010 and the second imaging device 1020 may be measured after installation of the first imaging device 1010 and the second imaging device 1020. Alternatively, using the known dimensions of the container 1000 and the images taken by at the electronic device 200 or the server 300, which depicts the interior of the container 1000, the spatial coordinates of the first imaging device 1010 and the second imaging device 1020 may be estimated.

In order to enhance the contrast of the package 100 in the images obtained by the first imaging device 1010 and the second imaging device 1020, the walls of the container may be a different colour than that of the package. When the images obtained by the first imaging device 1010 and the second imaging device 1020 are processed at the electronic device 200 or the server 300, the difference in color may render the identification of the package more straightforward.

Alternatively, a predetermined tag may be attached to the package 100. The examples of the predetermined tag may include an object with specific shape or colour such that it is easily recognised or tracked during the processing by the electronic device 200 and the server 300. When the images obtained by the first imaging device 1010 and the second imaging device 1020 are processed at the electronic device 200 or the server 300, the package 100 may be identified by identifying the position of this predetermined tag.

Alternatively, the position of the package 100 may be identified by the difference between images taken before and after the package 100 is loaded into the container 1000. This method does not require any arrangement of the colors of the packages or walls or any preparation of tags. The triangulation algorithm as described in the flowchart of FIG. 3 will be explained below with respect of this specific method of taking the difference between the before and after images.

In FIG. 2a, a triangle is defined within the interior of the container 1000 by the first imaging device 1010, the second imaging device 1020, and the package 100.

The first angle θ1 may be defined to be the angle between a line 1015 defined by connecting the positions of the first imaging device 1010 and the second imaging device 1020 and a line 1016 defined by connecting the positions of the first imaging device 1010 and the package 100.

The second angle θ2 may be defined to be the angle between the line 1015 defined by connecting the positions of the first imaging device 1010 and the second imaging device 1020 and a line 1017 defined by the line connecting the positions of the second imaging device 1020 and the package 100.

In S300, the dimensions, in this example the lengths of the sides of the interior of the container 1000, are identified. These dimensions may be stored in the server 300 and/or associated with the identification of the container 1000. The identification of the container may be associated with an identification of the first imaging device 1010 and an identification of the second imaging device 1020 installed within the container 1000. Alternatively, these dimensions may be input by the user when the package 100 is loaded or when the first indicator 110 is read by the electronic device 200.

In S310, the respective positions of the first imaging device 1010 and the second imaging device 1020 with respect to the container 1000 may be identified. As discussed above, these positions may be determined at the stage of installing the first imaging device 1010 and the second imaging device 1020 or the positions of the first imaging device 1010 and the second imaging device 1020 within the interior space of the container 1000 may be predetermined and the first imaging device 1010 and the second imaging device 1020 may be installed accordingly. In any case, it is crucial that the positions of the first imaging device 1010 and the second imaging device 1020 with respect to the walls of the interior of the container 1000 are known beforehand to execute the triangulation algorithm. These positions may be used, along with the dimensions of the container 1000, for the processing of the images obtained by the first imaging device 1010 and the second imaging device 1020.

The distance between the first imaging device 1010 and the second imaging device 1020 may be therefore established at this step and used for processing the images obtained by the first imaging device 1010 and the second imaging device 1020.

In S320, the images are obtained by the first imaging device 1010 and the second imaging device 1020. The first imaging device 1010 and the second imaging device 1020 may be running continuously. The images taken by the first imaging device 1010 and the second imaging device 1020 may be time-tagged or timestamped. Alternatively, the first imaging device 1010 and the second imaging device 1020 may only take a snap shot after a predetermined duration after the door 1030 is opened. Alternatively, the first imaging device 1010 and the second imaging device 1020 may take a snap shot, or short duration video footage at a regular interval, for example every minute, such that the amount of image generated is mitigated while capturing all of the events in relation to loading into or unloading out of the container 1000.

FIG. 2b shows the images obtained by the first imaging device 1010 before and after the package 100 is loaded. In this specific example shown in FIG. 2, the package 100 is the first package to be loaded into the container 1000.

FIG. 2c shows the images obtained by the second imaging device 1020 before and after the package 100 is loaded. In this example, it is assumed that the second imaging device 1020 is able to image the whole area of the interior of the container 1000. However, this may not be the case. There can be a dead area within the interior of the container 1000 which may not be captured by either of the first imaging device 1010 and the second imaging device 1020. In this case, a third imaging device 1030 may be installed to cover this dead area of the interior of the container 1000. The use of two imaging devices is a minimum prerequisite for executing a triangulation algorithm, but the number of the imaging devices is not limited to two, as in this example.

In processing these images, either the electronic device 200 or the server 300 may compare the two images before and after the package 100 is loaded. The difference between the two images may be used as a raw image that will be used to calculate the location of the package 100 within the container 1000.

To determine the point in time of before and after the package 100 is loaded, the user may specify points in time, using the electronic device 200, which correspond respectively to before and after the package 100 is loaded. For example, the user may actively instruct the first imaging device 1010 and the second imaging device 1020 to take images on the electronic device 200 before the user places the package 100 inside the container 1000. The user may subsequently instruct the first imaging device 1010 and the second imaging device 1020 to take another image after the user places the package 100 inside the container 1000.

Alternatively, the electronic device 200 or the server 300 may be configured to decide on the representative points in time which correspond respectively to before and after the package 100 is loaded. For example, if an image is stationary for longer than a predetermined time period, the image at any specific point in time during this period may be used as a representative image which can either be assigned as before or after the package 100 is loaded. Two of such images may be identified which are substantially close to each other in time and exhibit clear difference in a localised portion of the image, to be used as the before and the after images.

Other methods may be employed to determine the before and after images. For example, if the first imaging device 1010 and the second imaging device 1020 are arranged to take images regularly at a predetermined interval and the images obtained are time-stamped, the processor in the electronic device 200 or the server 300 may be arranged to decide on the image where the door 1030 is first openend. Then the processor in the electronic device 200 or the server 300 may designate the frame before the door opening as the ‘before’ image and the image after the door 1030 is closed again as the ‘after’ image.

In case the images are taken while the door 1030 is closed, the first imaging device 1010 and the second imaging device 1020 may be equipped with lighting devices, such as a flash light or an LED lamp.

An advantage of comparing images as shown in FIGS. 2b and 2c over using predetermined tags on the package 100 may be that not only the representative position of the package 100 but also the volume which the package 100 occupies or size of the package 100 can be estimated because the 3-dimensional projection of the package 100 is recorded by the first imaging device 1010 and the second imaging device 1020.

An advantage of comparing images as shown in FIGS. 2b and 2c over using a single image with the package 100 may be that when many packages are stored within the container 1000, additional package 100 may be hard to recognise and process. For example, if the package 100 is to be recognised by the first imaging device 1010 and the second imaging device 1020 by the predetermined tag, and the tag of the newly loaded package 100 is hidden behind other packages such that either one of the first imaging device 1010 and the second imaging device 1020 is not able to record the tag properly, the triangulation algorithm may not be performed.

The position of the package 100 may be determined to be the estimated centre of the package 100. For example, the first imaging device 1010 and the second imaging device 1020 may identify at least two sides of the package 100. Then assuming the package 100 is a cubic shape, the centre position of the package 100 and the dimensions of the sides of the package 100 may be estimated and stored in the server 300 as part of the information of the package 100. This aspect will be discussed in more detail below.

In case the first imaging device 1010 and the second imaging device 1020 can only identify one face of the package 100, the information of the neighbouring packages may be used to estimate the size and the central point of the package 100.

If the shape of the package 100 is not cubical, a predetermined template of other common shapes may be applied to estimate the central positions and identifiable faces of the package 100. For example, a processing routine for a cylindrical shape package may be prepared. Templates for other known shapes with variable dimensions may be stored in the server 300 for processing the position and the volume of the package 100.

In S330, the image obtained in step S32o by the first imaging device 1010 can be used to identify the first angle.

In S340, the image obtained in step S32o by the second imaging device 1020 can be used to identify the second angle.

Alternatively, the first angle and the second angle may be identified using the images obtained by the first imaging device 1010 and the second imaging device 1020 simultaneously.

The images obtained by the first imaging device 1010 and the second imaging device 1020 are 2-dimensional. In S330 and S340, considering the known positions of the first imaging device 1010 and the second imaging device 1020 and the dimensions of the container 1000, 3-dimensional coordinate of the package 100 may be evaluated. For example, the correspondence can be determined between the first angle and the second angle and various positions of the package 100 within the image obtained by the first imaging device 1010 and the second imaging device 1020. The correspondence between the coordinates in the 2-dimensional images obtained by the first imaging device 1010 and the second imaging device 1020 and the 3-dimensional coordinates within the interior space of the container 1000 can be obtained in advance. For example when the imaging devices are installed, a mapping information, which contains the correspondence may be tabulated and stored in the server 300, associated with the identity of the container 1000. If the calculation of FIG. 3 is performed by the electronic device 200, the electronic device 200 may access the server 300 to retrieve the mapping information.

In S350, the 3-dimensional coordinate of the package 100 may be calculated using the first angle, the second angle and the distance between the first imaging device and the second imaging device. This simple calculation is either performed at the electronic device 200 or the server 300.

The position of the package 100 may be in a form of a 3-dimensional coordinate. For example, if the package 100 is of a cubic shape, the lower rightmost corner of the interior of the container 1000 may be taken to be the origin of the 3-dimensional coordinate. The position of the package 100 may be represented as a 3-dimensional coordinate in any units of distance, such as centimetres. The position of the package 100 may be directed to the central position of the package estimated by the images obtained by the first imaging device 1010 and the second imaging device 1020. For example, when the package 100 is of a cube shape, the central position of the package can be estimated by taking the midpoint of the two opposite sides. For example, in FIG. 2a, if the dimension of a cubic package 100 is 100 cm×200 cm×400 cm, and if the package 100 is placed nearest to the lower rightmost corner, the origin, the position coordinate of the package 100 corresponds to (50, 100, 200), which points to the centre point of the package.

The example presented in FIG. 2 only shows the first package 100 to be loaded. However, the same principle can be applied to the subsequent packages. The processing of the images for subsequent packages can take into consideration of the position and the volume of the previously loaded packages which are stored in the server 300. Therefore, a 3-dimensional map of all of the packages 100 inside the container 1000 may be constructed.

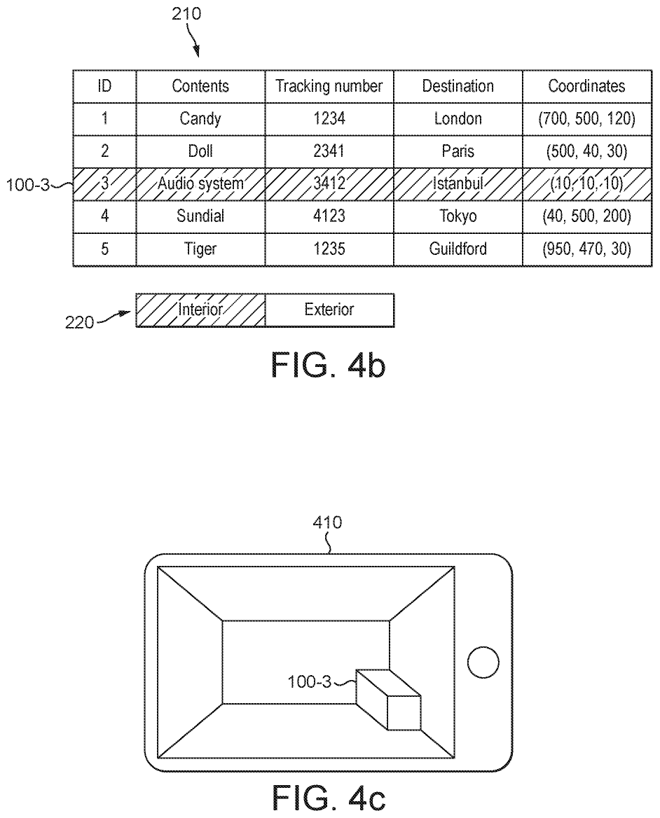

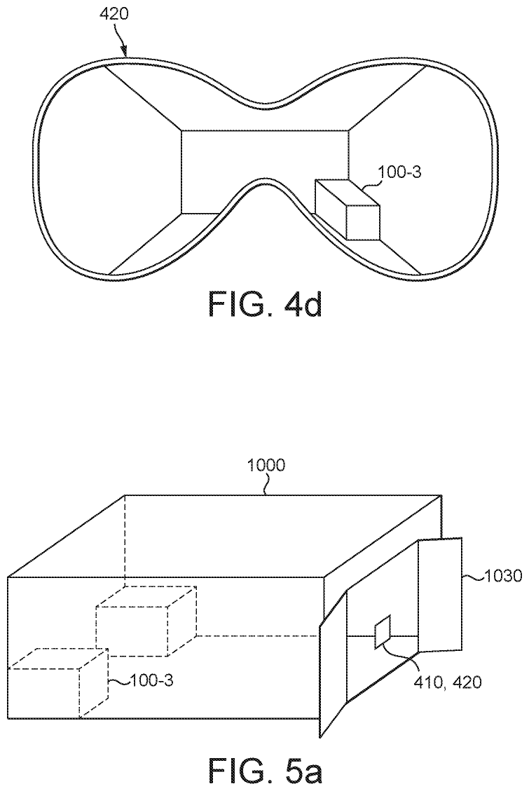

FIGS. 4a, 4b, 4c and 4d describe how the package 100 within the container can be retrieved and located once the container 1000 arrives at a destination or an intermediate location where the container 1000 is stationed. In these places, the container 1000 may need to be opened and the package 100 may need to be placed and taken out of the container 1000 in an efficient fashion.

In FIG. 4a, the second indicator 120 attached and displayed on the container 1000 may be sensed or read by the electronic device 200. The electronic device 200 may subsequently communicate with the server 300 to retrieve information associated with all of the packages 100 registered to be included in the container 1000, using the second indicator 120 as a reference.

Alternatively, the second indicator 120 may not merely be a pointer or a reference to the information stored in the server 300 but store the necessary information associated with all of the packages 100 within the container 1000. For example, the second indicator may be in text and the electronic device 200 may be able to scan and receive input from the second indicator using methods such as optical character recognition (OCR).

FIG. 4b shows a first user interface 210 included in the electronic device 200. The information associated with all of the packages 100 included in the container 1000 may be listed once received by the electronic device 200 via the methods discussed above. The first user interface 210 may allow the user to view the information of all of the packages 100-1, 100-2, 100-3, 100-4, 100-5, included in the container 1000. The first user interface 210 may allow the user to select one or more of the packages 100-1, 100-2, 100-3, 100-4, 100-5 the user wants to unload out of the container 1000. If the electronic device 200 is a mobile phone, the list of packages 100-1, 100-2, 100-3, 100-4, 100-5 are shown on the screen of the mobile phone and the user may select one or more of the packages 100-1, 100-2, 100-3, 100-4, 100-5 by touching on the screen. In this example, there are 5 packages in the container 1000. The user may select one of the packages, in this example package number 3, 100-3, to retrieve the information on the 3-dimensional position of the package 100-3.

FIG. 4b also shows a second user interface 220 included in the electronic device 200. The second user interface 220 may be arranged to appear when one of the packages listed in the first user interface 210 is selected by the user. The second user interface 220 may prompt the user to select whether the user wants the interior of the container or the exterior of the container to be visualised on an augmented reality interface 410, 420. In this example, the user chooses to view the interior of the container 1000. Alternatively, the second user interface 220 may not be necessary. The processor in the electronic device may be arranged to decide whether the user is viewing the exterior or the interior of the container 1000 based on the image obtained by the electronic device 200.

FIG. 4c shows the augmented reality interface 410. The augmented reality interface 410 may be included in the electronic device 200. For example, when the electronic device is a mobile phone, the augmented reality device may be implemented as a specialised software application installed in a memory of the electronic device 200, for example, the mobile phone using the internal camera of the mobile phone. The camera of the mobile phone may image the container 1000 and the augmented reality interface 410 may indicate the 3-dimensional position of the package 100-3 on the image being displayed in the electronic device such that the 3-dimensional position of the package 100-3 is indicated intuitively in terms of the user's spatial perception in the displayed image. The augmented reality interface 410 may be moved around by the user holding the electronic device 200 containing the augmented reality interface 410. The position of the indication of the 3-dimensional position of the package 100-3 may be moved around such that the indication seems to the user as if it were the part of the scene.

FIG. 4d shows an alternative augmented reality interface 420. The augmented reality interface 420 may be a stand-alone goggle type device, which the user can wear on the user's head. The goggle type augmented reality interface 420 may operate in a similar fashion to the augmented reality interface 410. The scene the user views through the goggle type augmented reality interface 420 is augmented by the indication of the 3-dimensional position of the package 100-3. The stand-alone goggle augmented reality interface 420 may be configured to communicate with the electronic device 200, either in a wireless fashion or via a cable or wire.

Alternatively, the electronic device 200 may also be included in the stand-alone goggle type augmented reality interface 420 with a user input capability, for example, input button installed around the brim of the goggle part of the augmented reality interface 420. The first indicator 110 and the second indicator 120 may be read in using the stand-alone goggle augmented reality interface 420 as the electronic device 200.

By using the augmented reality interface 410, 420, without searching through and sensing the first indicator 110 attached on each one of the packages 100-1, 100-2, 100-3, 100-4, 100-5, the user, or robotic apparatus viewing the interface, is guided to the location of the package 100-3 within the interior of the container 1000. This is especially effective when there are a large number of packages within the container 1000.

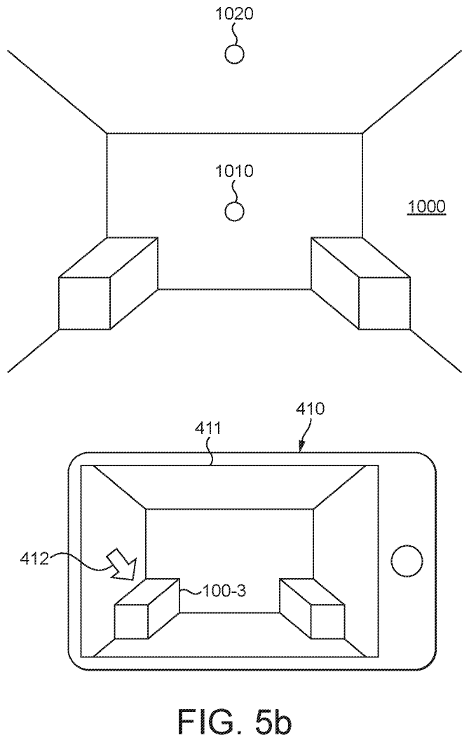

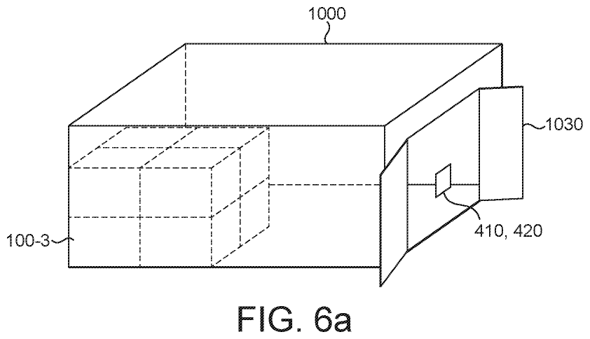

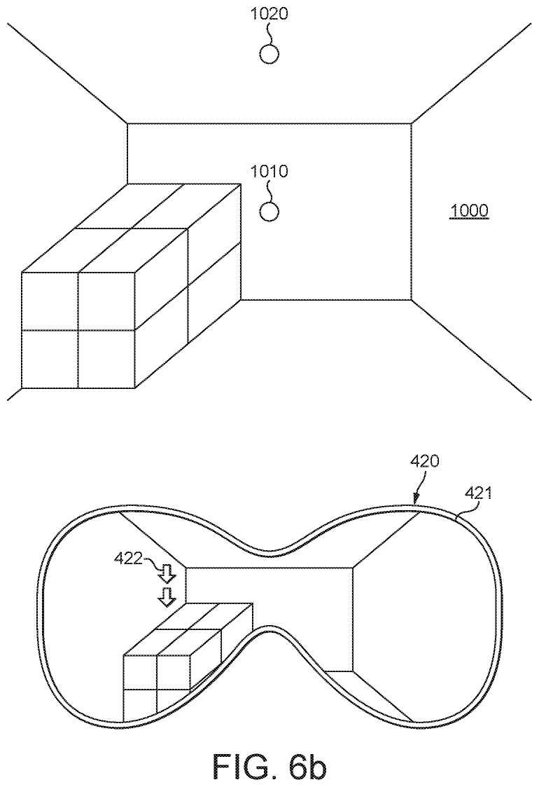

FIGS. 5a, 5b, 6a and 6b show how the package 100-3 is searched and unloaded using the augmented reality interface 410, 420 to image the interior of the container.

In FIG. 5a, to locate the desired package 100-3 inside the container 1000, the augmented reality interface 410, 420 may be used to view the interior of the container 1000, as described above in FIG. 4. The door 1030 may be open for this mode of operation, both to view and image the interior of the container and to unload the package 100-3. In this specific example, the desired package 100-3 is located lower leftmost corner of the container 1000 and there is one more package, in the upper 3 leftmost corner of the interior of the container 1000.

In FIG. 5b, the upper part of the FIG. 5b describes the interior of the container 1000 as viewed by the user through the door 1030. The first imaging device 1010 and the second imaging device 1020 are shown to be located on the back wall and the top wall, respectively, of the interior of the container 1000. The lower part of the FIG. 5b shows display 411 of the augmented reality interface 410. In this example, it is assumed that the user is holding the augmented reality interface 410 such that the internal camera of the augmented reality interface 410 images the interior of the container 1000. The electronic device 200, in which the augmented reality interface 410 is included, received the position information of the package 100-3, in particular the 3-dimensional coordinate of the package 100-3 in the procedure described in FIG. 4b. Overlaid with the image of the interior of the container 1000, the augmented reality interface 410 may process this 3-dimensional coordinate of the package 100-3 and show a pointer 412 indicating the desired package 100-3.

The type of augmented reality interface 410, 420 is not limited to mobile phone application type 410 or stand-alone goggle type 420 in this example.

To display the position of the desired package 100-3, the augmented reality interface 410, 420 must be able to recognise the parts of the interior of the container 1000. When the augmented reality interface 410, 420 images the interior of the container 1000, the walls of the interior of the container in the image must be identified by the processor of the electronic device 200. For this purpose, the augmented reality interface 410, 420 may use the known dimensions of the interior of the container 1000. The augmented reality interface 410, 420 may detect the walls. The augmented reality interface 410, 420 may detect the lines defined at the boundaries of the walls. The augmented reality interface 410, 420 may also detect the position of the first imaging device 1010 and the second imaging device 1020. The walls of the container 1000 may contain predetermined markers for the augmented reality interface 410, 420 to recognise.

FIG. 6a shows a similar example as in FIG. 5a. In this specific example, the desired package 100-3 is again located lower leftmost corner of the container 1000 and there are seven other packages piled around and on top of the desired package 100-3 such that the desired package 100-3 is hidden by the other packages.

In FIG. 6b, the upper part of the FIG. 6b describes the interior of the container 1000 as viewed by the user through the door 1030. The lower part of the FIG. 6b shows display 421 of the augmented reality interface 420. The specific type of the augmented reality interface is irrelevant. On top of the image of the interior of the container 1000, the augmented reality interface 420 may show a pointer 422 indicating the desired package 100-3. In order to indicate that there is one other package blocking the access of the user to the desired package 100-3, the pointer 422 may comprise two arrows. The specific fashion in which the position of the desired package 100-3 is indicated in the display 421 is not limited to this example, namely the number of arrows. For another example, a 3-dimensional representation of the contours of the pile of the packages may be displayed to guide the user to the location of the desired package 100-3.

After unloading the desired package 100-3, the rest of the packages needs to be rearranged. The resulting rearrangement of the packages may be detected by the first imaging device 1010 and the second imaging device 1020. The augmented reality interface 410, 420 may recommend the users with a suitable way of rearranging the packages after unloading the desired package 100-3.

After unloading the desired package 100-3, the rearrangement of the package may be transmitted to the server 300 by the first imaging device 1010 and the second imaging device 1020, directly to the server 300 or via the electronic device 200 or via the augmented reality device 410, 420.

The augmented reality interface 410, 420, after the rest of the packages are rearranged may prompt the user to identify some of the packages such that the position information of those packages are updated in the server 300.

The serve 300 in that case may generate the second indicator 120 again updating the list and the new arrangement of the packages in the container 1000.

By using the augmented reality interface 410, 420, without searching through and sensing the first indicator 110 attached on each one of the packages, the user is guided to the location of the package 100-3 within the interior of the container 1000 even when the package 100-3 is hidden by other packages from the view through the augmented reality interface 410, 420.

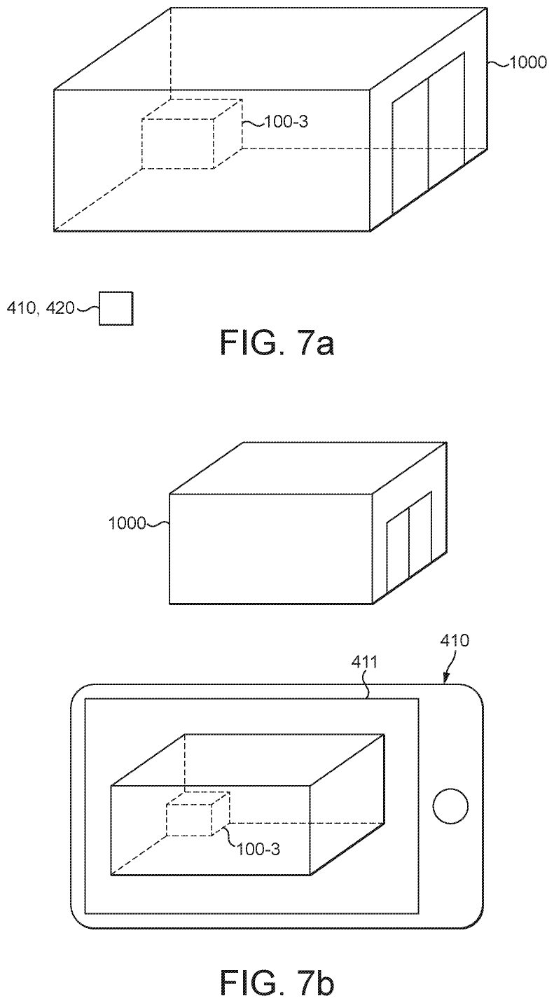

FIGS. 7a and 7b show how the package 100-3 is located and the user is guided using the augmented reality interface 410, 420 when the augmented reality interface 410, 420 are used to image the exterior of the container.

In FIG. 7a, to locate the desired package 100-3 inside the container 1000, the augmented reality interface 410, 420 may be used to view the exterior of the container 1000. The door 1030 may be kept closed for this mode of operation. This mode of operation may be used when the position of the package 100-3 needs to be identified without opening the door 1030 of the container 1000, or when the positions of more than one package need to be identified before opening the door 1030. In this specific example, the desired package 100-3 is located upper leftmost corner of the container 1000 and there are no other packages.

In FIG. 7b, the upper part of the FIG. 7b describes the exterior of the container 1000 as viewed by the user. The lower part of the FIG. 7b shows display 411 of the augmented reality interface 410. The specific type of the augmented reality interface is again irrelevant. The operating principle is similar to that described in FIG. 4c and FIG. 5b. Overlaid with the image of the interior of the exterior container 1000, the augmented reality interface 420 may show three additional hidden surfaces and the volume occupied by the desired package 100-3.

As shown in FIG. 6b, in case there are other packages around the desired package 100-3, a suitable three-dimensional representation of the packages or a suitable form of a marker or pointer may be used to direct the user viewing the display 411, 421 of the augmented reality interface 410, 420.

To display the position of the desired package 100-3, the augmented reality interface 410, 420 must be able to recognise the parts of the exterior of the container 1000. When the augmented reality interface 410, 420 images the exterior of the container 1000, the external surfaces of the container in the image must be identified by the processor of the electronic device 200. For this purpose, the augmented reality interface 410, 420 may use the known dimensions of the exterior of the container 1000. The augmented reality interface 410, 420 may detect the walls visible. The augmented reality interface 410, 420 may detect the lines defined at the boundaries of the walls. The exterior walls of the container 1000 may contain predetermined markers for the augmented reality interface 410, 420 to recognise. The augmented reality interface 410, 420 may detect the texts or pictures or trademark on the exterior surface of the container 1000.

As shown by the embodiments described so far, an advantage of the apparatus and method described herein is that since the second indicator 120 attached on the container 1000 serves as a convenient label, the details of the packages inside the container 1000 do not need to be recorded separately or remembered by the user. Location and unloading of each package will be efficient because the augmented reality interface 410, 420 shows the user immediately where in the container 1000 the package 1o is located. Since the three dimensional representation on the augmented reality interface 410, 420 are intuitive, it will be convenient to identify the package even when the desired package 100-3 is completely covered by other packages. In case the exterior of the container 1000 is imaged by the augmented reality interface 410, 420, the door 1030 of the container 1000 does not need to be open.

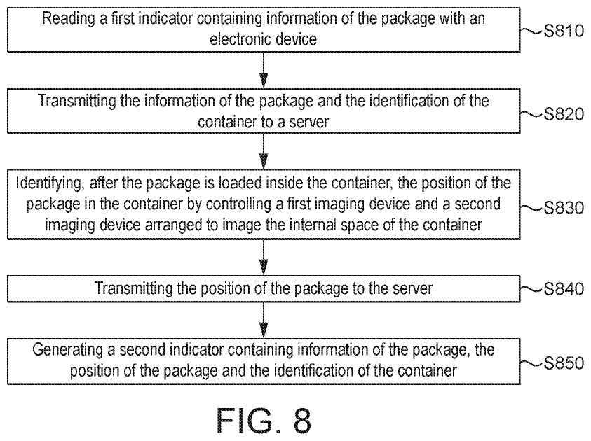

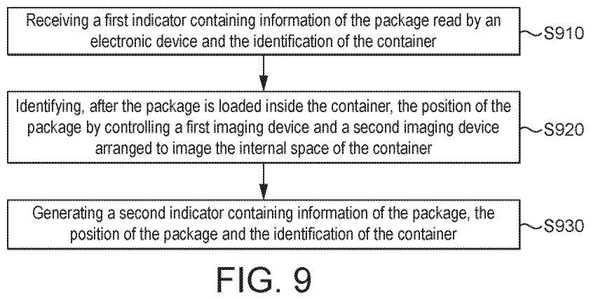

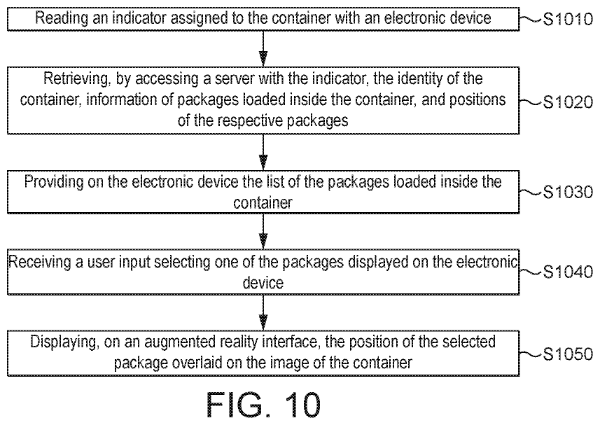

FIGS. 8 to 10 illustrate methods of loading and unloading a container in accordance with the above embodiments and alternatives.

The embodiments of the invention shown in the drawings and described above are exemplary embodiments only and are not intended to limit the scope of the invention, which is defined by the claims hereafter. It is intended that any combination of non-mutually exclusive features described herein are within the scope of the present invention.

1. A method of loading a package inside a container, the method comprising:
reading a first indicator containing information of the package with an electronic device;
transmitting the information of the package and the identification of the container to a server;
identifying, after the package is loaded inside the container, the position of the package in the container by controlling a first imaging device and a second imaging device arranged to image the internal space of the container;
transmitting the position of the package to the server;
generating a second indicator containing information of the package, the position of the package and the identification of the container.

2. A method of loading a package inside a container, the method comprising:
receiving a first indicator containing information of the package read by an electronic device and the identification of the container;
identifying, after the package is loaded inside the container, the position of the package by controlling a first imaging device and a second imaging device arranged to image the internal space of the container;
generating a second indicator containing information of the package, the position of the package and the identification of the container;

3. A method according to 2, wherein the identifying comprises estimating the position of the package relative to the walls of the container via a triangulation algorithm.

4. A method according to claim 3, wherein the walls of the container are a different colour than that of the package.

5. A method according to claim 3, wherein a predetermined tag is attached to the package, wherein the predetermined tag is recognisable by the first imaging device and the second imaging device.

6. A method according to claim 3, wherein the identifying further comprises obtaining a first image before the package is loaded into the container, obtaining a second image after the package is loaded into the container, and comparing the first image and the second image.

7. A method according to claim 2, wherein the first imaging device is installed on a side surface of the container and the second imaging devices is installed on a top surface of the container.

8. A method of locating a package inside a container, the method comprising:
reading an indicator assigned to the container with an electronic device;
retrieving, by accessing a server with the indicator, the identity of the container, information of packages loaded inside the container, and positions of the respective packages;
providing on the electronic device the list of the packages loaded inside the container;
receiving a user input selecting one of the packages displayed on the electronic device;
displaying, on an augmented reality interface, the position of the selected package overlaid on the image of the container.

9. A method according to claim 8, wherein the augmented reality interface is included in the electronic device and the electronic device further comprises an imaging device, such that the augmented reality interface displays the image obtained by the imaging device.

10. A method according to claim 8, wherein the method further comprises receiving a further user input regarding whether the exterior or the interior of the container is to be imaged on the augmented reality interface.

11. A method according to claim 10, wherein if the user input is received for imaging the interior of the container, the displaying on the augmented reality interface further comprises:
determining, from the image of the interior of the container, the surfaces corresponding to the walls of the interior the container;
displaying a 3-dimensional object corresponding to the combination of the determined surfaces, such that the 3-dimensional object represents the internal space of the container, overlaid with the displayed image of the interior of the container; and
displaying a pointer pointing to the position of the selected package overlaid on the image of the internal space of the container.

12. A method according to claim 11, wherein if at least one or more packages block the selected package from being displayed on the augmented reality interface, the displaying on the augmented reality interface further comprises displaying a pointer pointing to the one or more packages blocking the selected package.

13. A method according to claim 10, wherein if the user input is received for imaging the exterior of the container, the displaying on the augmented reality interface further comprises:
determining, from the image of the exterior of the container, visible external surfaces and hidden external surfaces corresponding to the walls of the container;
displaying a 3-dimensional object corresponding to the combination of the determined surfaces, such that the 3-dimensional object represents the space occupied by the container, overlaid with the displayed image of the container; and
displaying a pointer indicating the position of the selected package within the 3-dimensional object.

14. A method according to claim 1, wherein the identifying comprises estimating the position of the package relative to the walls of the container via a triangulation algorithm.

15. A method according to claim 14, wherein the walls of the container are a different colour than that of the package.

16. A method according to claim 14, wherein a predetermined tag is attached to the package, wherein the predetermined tag is recognisable by the first imaging device and the second imaging device.

17. A method according to claim 14, wherein the identifying further comprises obtaining a first image before the package is loaded into the container, obtaining a second image after the package is loaded into the container, and comparing the first image and the second image.

18. A method according to claim 1, wherein the first imaging device is installed on a side surface of the container and the second imaging devices is installed on a top surface of the container.

19. A method according to claim 14, wherein the first imaging device is installed on a side surface of the container and the second imaging devices is installed on a top surface of the container.

20. A method according to claim 9, wherein the method further comprises receiving a further user input regarding whether the exterior or the interior of the container is to be imaged on the augmented reality interface.
